(19) United States
(12) Patent Application Publication
(10) Pub. No.: US 2025/0336218 A1
(43) Pub. Date: Oct. 30, 2025

(54) ASSISTANCE APPARATUS AND ASSISTANCE METHOD

(71) Applicant: TOYOTA JIDOSHA KABUSHIKI KAISHA, Toyota-shi (JP)

(72) Inventors: Shunji TATEISHI, Kasugai-shi (JP); Toshinori Kimura, Shinagawa-ku (JP); Kumpei Akiyama, Chuo-ku (JP); Kohei Naganuma, Setagaya-ku (JP)

(73) Assignee: TOYOTA JIDOSHA KABUSHIKI KAISHA, Toyota-shi (JP)

(21) Appl. No.: 19/169,351

(22) Filed: Apr. 3, 2025

(30) Foreign Application Priority Data
Apr. 26, 2024 (JP) 2024-072863

(51) Int. Cl. G06V 20/60; B60Q 9/00; G06T 7/60; G06V 10/764

(52) U.S. Cl. CPC G06V 20/60; B60Q 9/00; G06T 7/60; G06V 10/764

(57) ABSTRACT

An assistance apparatus includes a controller configured to determine a type of luggage that a user brings into a vehicle based on an acquired camera image and measure a dimension of the luggage, and present a predetermined luggage storage space to the user in a case in which the determined type of the luggage is predetermined luggage or in a case in which the measured dimension of the luggage is larger than a threshold.

### CROSS-REFERENCE TO RELATED APPLICATION

This application claims priority to Japanese Patent Application No. 2024-072863 filed on Apr. 26, 2024, the entire contents of which are incorporated herein by reference.

### TECHNICAL FIELD

The present disclosure relates to an assistance apparatus and an assistance method.

### BACKGROUND

Technology related to storing luggage that users bring into vehicles is known. For example, Patent Literature (PTL) 1 discloses an information provision apparatus that prevents the unloading of users and luggage of the users at a predetermined location from being forgotten.

### CITATION LIST

### Patent Literature

PTL 1: JP 2014-229053 A

### SUMMARY

However, there is a problem that, when there is a lot of luggage to be brought into the vehicle, users have trouble finding a place to put their luggage. Therefore, there is room for improvement with respect to technology related to storing luggage that users bring into vehicles.

It would be helpful to improve technology related to storing luggage that users bring into vehicles.

An assistance apparatus according to an embodiment of the present disclosure is an assistance apparatus including:

an input interface including a camera; and

a controller configured to:
acquire a camera image captured by the camera;
determine a type of luggage that a user brings into a vehicle based on the acquired camera image and measure a dimension of the luggage; and
present a predetermined luggage storage space to the user in a case in which the determined type of the luggage is predetermined luggage or in a case in which the measured dimension of the luggage is larger than a threshold.

An assistance method according to an embodiment of the present disclosure is performed by an assistance apparatus and includes:

determining a type of luggage that a user brings into a vehicle based on an acquired camera image;

measuring a dimension of the luggage; and

presenting a predetermined luggage storage space to the user in a case in which the determined type of the luggage is predetermined luggage or in a case in which the measured dimension of the luggage is larger than a threshold.

According to an embodiment of the present disclosure, technology related to storing luggage that users bring into vehicles is improved.

### BRIEF DESCRIPTION OF THE DRAWINGS

In the accompanying drawings:

FIG. 1 is a block diagram illustrating a schematic configuration example of a system according to an embodiment of the present disclosure;

FIG. 2 is a flowchart illustrating an example of operations of an assistance apparatus;

FIG. 3 is a schematic diagram illustrating an example of operations of the assistance apparatus; and

FIG. 4 is a schematic diagram illustrating an example of a luggage storage space in a vehicle.

### DETAILED DESCRIPTION

Hereinafter, an embodiment of the present disclosure will be described.

### Outline of Embodiment

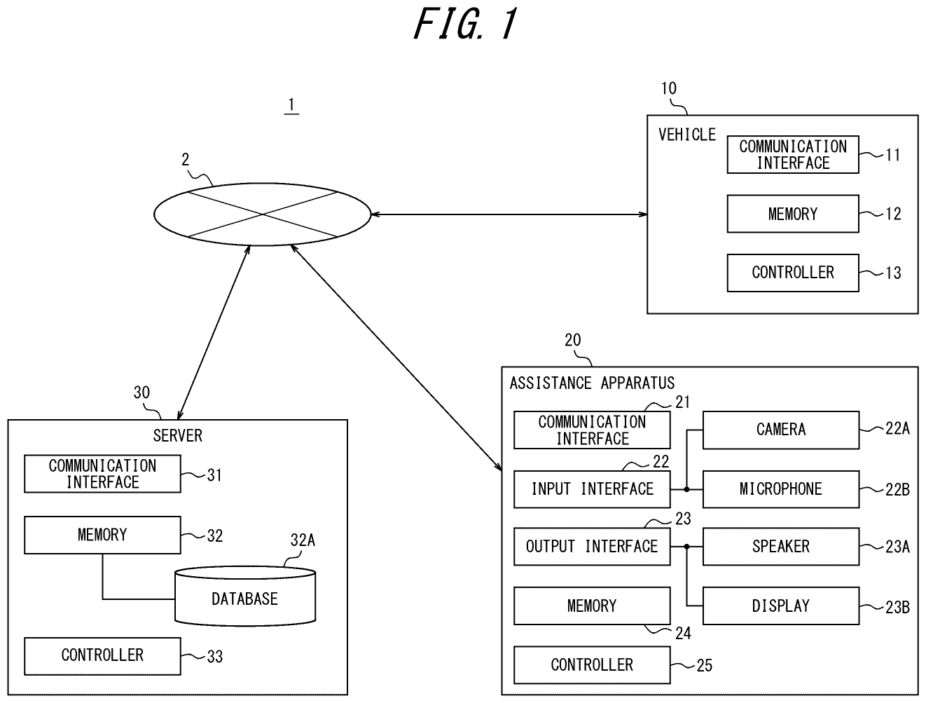

An outline of a system 1 according to the embodiment of the present disclosure will be described with reference to FIG. 1. The system 1 includes a vehicle 10, an assistance apparatus 20, and a server 30. The vehicle 10, the assistance apparatus 20, and the server 30 are communicably connected with a network 2 including, for example, the Internet, a mobile communication network, and the like.

The vehicle 10 is an automobile, for example, but is not limited to this and may be any appropriate vehicle. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. In this disclosure, the vehicle 10 shall be, but is not limited to, a transit bus (on-demand bus) that operates on a predetermined route. The number of vehicles 10 provided in the system 1 may be freely determined. The vehicle 10 can communicate with the assistance apparatus 20 and the server 30 via the network 2.

The assistance apparatus 20 is a terminal apparatus installed at the stop where the vehicle 10 stops. The assistance apparatus 20 presents the user boarding the vehicle 10 with a storage area (luggage storage space) for luggage to be brought into the vehicle 10. The assistance apparatus 20 is communicably connected to the vehicle 10 and the server 30 via the network 2.

The server 30 is, for example, a computer owned by the operator of the business operating the vehicle 10. The server 30 can communicate with the vehicle 10 and the assistance apparatus 20 via the network 2.

First, an outline of the present embodiment will be described, and details thereof will be described later. The assistance apparatus 20 determines the type of luggage that a user 3 brings into the vehicle 10 based on an acquired camera image and measures the dimension of the luggage, and presents a predetermined luggage storage space to the user 3 if the determined type of the luggage is predetermined luggage or if the measured dimension of the luggage is larger than a threshold.

Thus, according to the present embodiment, if the type of luggage is predetermined luggage, or if the measured dimension of the luggage is larger than a threshold, a predetermined luggage storage space is presented to the user 3 of the vehicle 10. This improves the technology related to storing luggage that users bring into vehicles in that the user 3 can place their bulky luggage in the predetermined luggage storage space, so that the luggage does not get in the way of other users and improves the comfort of the user 3. Next, configurations of the system I will be described in detail.

### Configuration of Vehicle

As illustrated in FIG. 1, the vehicle 10 includes a communication interface 11, a memory 12, and a controller 13.

The communication interface 11 includes a communication interface for wireless connection to the network 2. The communication interface for connecting to the network 2 is compliant with a mobile communication standard such as the 4th generation (4G) standard or the 5th generation (5G) standard, but is not limited to these.

The memory 12 includes one or more memories. The memories are, for example, semiconductor memories, magnetic memories, optical memories, or the like, but are not limited to these. The memories included in the memory 12 may each function as, for example, a main memory, an auxiliary memory, or a cache memory. The memory 12 stores any information to be used for the operations of the vehicle 10. For example, the memory 12 may store a system program, an application program including a car navigation application, embedded software, operation information for the vehicle 10, map information, and the like. The information stored in the memory 12 may be updated with, for example, information acquired from the network 2 via the communication interface 11.

The controller 13 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 13 controls operations of the entire vehicle 10.

### Configuration of Assistance Apparatus

As illustrated in FIG. 1, the assistance apparatus 20 includes a communication interface 21, an input interface 22, an output interface 23, a memory 24, and a controller 25.

The communication interface 21 includes a communication interface for wireless connection to the network 2. The communication interface for connecting to the network 2 is compliant with, for example, a mobile communication standard, a wired LAN standard, a wireless LAN standard, or the like, but is not limited to these, and may be compliant with any communication standard.

The input interface 22 is configured with an interface for input that can input camera images and audio. The interface for input is, for example, a camera 22A that captures camera images of the user 3 and the luggage that the user 3 brings into the vehicle 10, and a microphone 22B that captures the audio of the user 3. However, the interface for input is not limited to these. The input interface 22 outputs camera images captured by the camera 22A and audio collected by the microphone 22B to the controller 25.

The camera 22A is, for example, a video camera installed on a pole at the stop where the vehicle 10 stops and captures moving images or still images. The camera 22A captures images of the user 3's face, body, and luggage that the user 3 brings into the vehicle 10.

The output interface 23 is configured with at least one audio output interface that can output audio, and at least one display interface that can display text or video. The audio output interface is, for example, a speaker 23A. The display interface is, for example, a display 23B such as an LCD or an organic EL display.

The memory 24 includes one or more memories. The memories included in the memory 24 may each function as, for example, a main memory, an auxiliary memory, or a cache memory. The memory 24 stores any information to be used for operations of the assistance apparatus 20. For example, the memory 24 may store a system program, an application program including a measurement application for measuring the dimension of luggage, and the like. The memory 24 registers user information for the user 3. The information stored in the memory 24 may be updated with, for example, information acquired from the network 2 via the communication interface 21.

The controller 25 includes at least one processor, at least one programmable circuit, at least one dedicated circuit, or a combination of these. The controller 25 controls operations of the entire assistance apparatus 20.

### Configuration of Server

As illustrated in FIG. 1, the server 30 includes a communication interface 31, a memory 32, and a controller 33.

The communication interface 31 includes at least one interface for communication for connecting to the network 2. The interface for communication is compliant with, for example, a mobile communication standard, a wired LAN standard, or a wireless LAN standard, but not limited to these, and may be compliant with any communication standard. In the present embodiment, the server 30 communicates with the vehicle 10 and the assistance apparatus 20 via the communication interface 31 and the network 2.

The memory 32 includes one or more memories. The memories included in the memory 32 may each function as, for example, a main memory, an auxiliary memory, or a cache memory. The memory 32 stores any information used for operations of the server 30. For example, the memory 32 may store a system program, a database, an application program, and the like. Furthermore, the memory 32 is equipped with a database 32A that stores user information for the user 3. The information stored in the memory 32 may be updated with, for example, information acquired from the network 2 via the communication interface 31.

The controller 33 includes at least one processor, at least one programmable circuit, at least one dedicated circuit, or a combination of these. The controller 33 controls the operations of the entire server 30.

### Flow of Operations of Assistance Apparatus

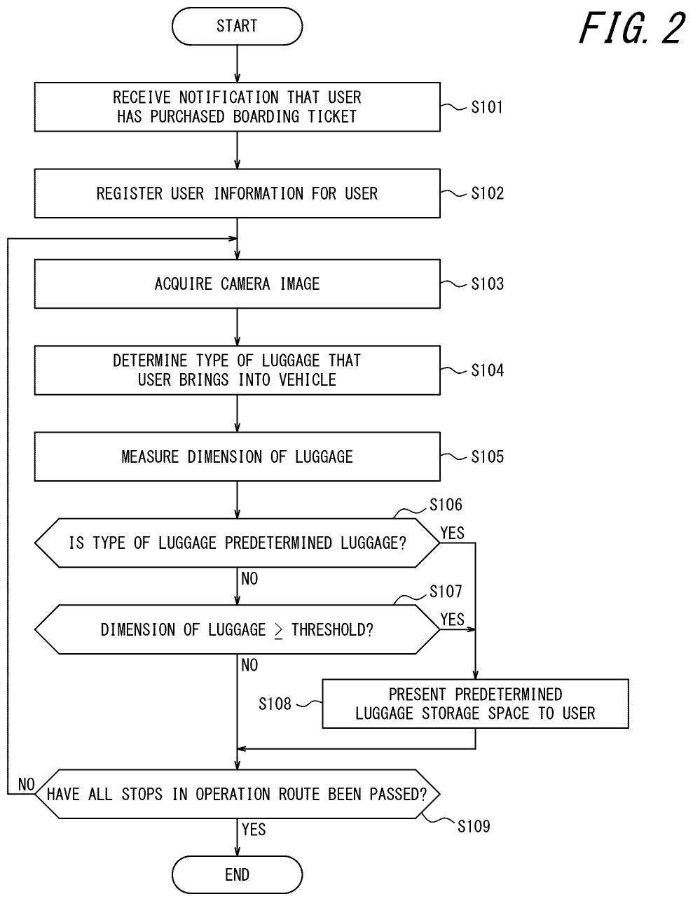

Operations of the assistance apparatus 20 according to the present embodiment will be described with reference to FIG. 2. This operation relates to storing luggage that the user 3 brings into the vehicle 10.

S101: The controller 25 receives a notification from the server 30 that the user 3 has purchased a boarding ticket for the vehicle 10.

In this disclosure, the vehicle 10 shall be, but is not limited to, an on-demand bus (passenger bus). The user 3 purchases a boarding ticket online on a website published by a server 30 owned by the operator that runs business to operate the vehicle 10. When the purchase of a boarding ticket is completed, the controller 25 receives a notification from the server 30 that the purchase of a boarding ticket for the vehicle 10 by the user 3 who plans to ride in the vehicle 10 is complete.

S102: the controller 25 registers user information for the user 3.

When purchasing a boarding ticket online, the user 3 enters user information on a website published by the server 30. The controller 33 of the server 30 accepts user information input by the user 3 and registers the accepted user information in the database 32A provided in the memory 32. The controller 33 transmits the user information of the registered user 3 to the vehicle 10 that the user 3 reserves a ride in and to the assistance apparatus 20 installed at the stop where the vehicle 10 stops. The controller 25 registers the received user information of the user 3 in the memory 24 as the user information of the person who reserved the ride.

User information includes basic information such as the address, name, and contact information (phone number, e-mail address) of the user 3. The user information also includes a facial image to identify the user 3. In addition, the user information may include an audio model of the user 3 who uttered the predetermined phrase.

S103: The controller 25 acquires camera images captured by the camera 22A.

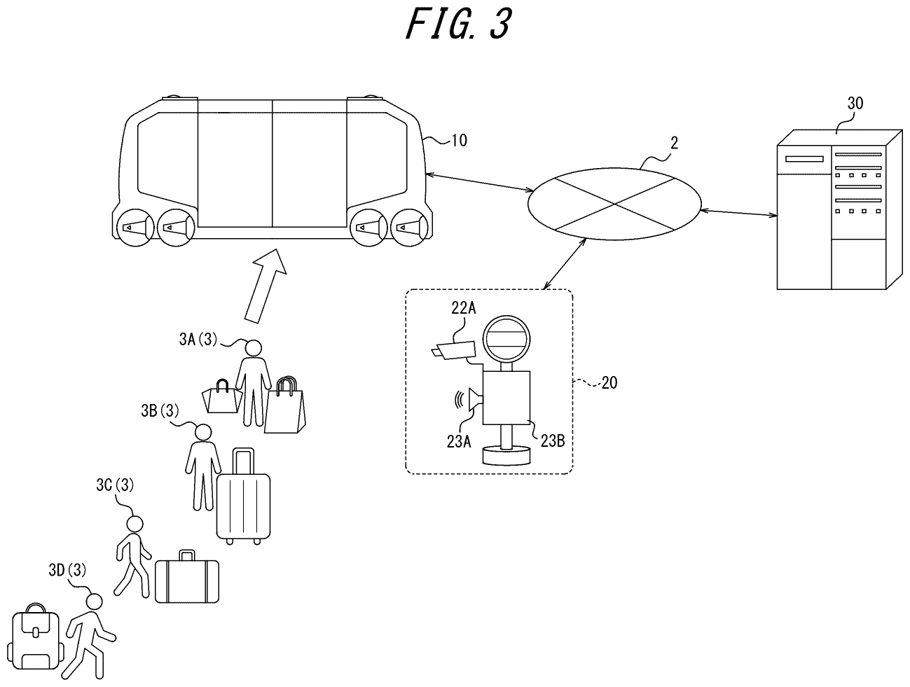

FIG. 3 is a schematic diagram illustrating an example of operations of the assistance apparatus 20. In the example illustrated in FIG. 3, four users 3 (e.g., 3A, 3B, 3C, 3D) board the vehicle 10 at the stop where the assistance apparatus 20 is installed. In this disclosure, the assistance apparatus 20 shall be installed on a pole at the stop, but the location of the assistance apparatus 20 is not limited to this. The assistance apparatus 20 is equipped with a camera 22A that captures moving images or still images. The users 3 (3A, 3B, 3C, 3D) have luggage of various types and of various dimensions, which they shall bring into the vehicle 10. The input interface 22 uses the camera 22A to capture camera images of the face of the user 3 and the luggage that the user 3 brings into the vehicle 10, and outputs the captured camera images to the controller 25.

The controller 25 verifies the identity of the user 3 by matching the captured face image of the user 3 with the face image of the user 3 included in the user information registered in the memory 24. The controller 25 authorizes the user 3, whose identity has been verified, to get into the vehicle 10. The input interface 22 may use the microphone 22B to capture the audio of the user 3 who utters a predetermined phrase, for example, “the name of the user 3”, “get on, get off”, and so on. The controller 25 may verify the identity of the user 3 by matching the audio of the user 3 who uttered the predetermined phrase with the audio model of the user 3 extracted by voiceprint analysis of the above predetermined phrase uttered by the user 3 in the user information.

S104: The controller 25 determines the type of luggage b that the user 3 brings into the vehicle 10 from the acquired camera image.

In this disclosure, the type of the luggage b is a classification based on the type of the luggage b, such as bags, handbags, backpacks, travel bags, and suitcases. However, the type of the luggage b is not limited to these. The type of the luggage b may be a classification based on the transportation regulations for the luggage b, such as portable hand luggage b1, consigned hand luggage b2, and hand luggage b3 that cannot be brought into the vehicle 10. The portable hand luggage b1 is hand luggage that each user 3 can bring into the cabin, such as bags, handbags, backpacks, and travel bags. The consigned hand luggage b2 is hand luggage that the vehicle 10 (carrier) receives from the user 3 and transports, such as backpacks, travel bags, and suitcases. Backpacks and travel bags shall be classified as either the portable hand luggage b1 or the consigned hand luggage b2, depending on their dimensions. The hand luggage b3 that cannot be brought into the vehicle 10 is hand luggage that cannot be transported due to laws and regulations or carrier regulations, such as animals, plants, or dangerous goods.

S105: The controller 25 measures the dimension of the luggage b.

The controller 25 starts a measurement application stored in the memory 24 to measure the dimension of the luggage b and measures the dimension of the luggage b. A measurement application is an application that uses Augmented Reality (AR) technology to measure the dimensions (height×width×depth (cm)), total dimensions of three sides (height+width+depth (cm)), and area (cm²) of a subject reflected in a camera. In this disclosure, the dimensions of the luggage b are assumed to be the total dimensions of the three sides of the subject, but may be any dimension. The method of measuring the dimensions of the luggage b is not limited to the method using the measurement application, but any method may be used.

S106: The controller 25 checks whether the determined type of the luggage b is predetermined luggage bp. If it is the predetermined luggage bp, go to S108; if it is not the predetermined luggage bp, go to S107.

The predetermined luggage bp is, for example, a suitcase. Since the predetermined luggage bp corresponds to relatively bulky luggage, placing it in the predetermined luggage storage space improves the comfort of the user 3 because the luggage b does not get in the way of other users. However, the predetermined luggage bp is not limited to suitcases and may be set freely.

S107: The controller 25 determines whether the measured dimension of the luggage b is larger than the threshold α. If larger than or equal to the threshold α, go to S108; if not larger than or equal to the threshold α, go to S109.

The controller 25 measures the dimension of the luggage b, which is included in the acquired camera image, using the measurement application. Using the measurement application, the controller 25 measures, for example, if the height×width×depth (cm) dimensions of a travel bag are 30×60×26 (cm), the total dimensions of the three sides of the travel bag are 116 (cm).

In this disclosure, the threshold α is specified as 100 (cm), for example. The controller 25 determines that the dimensions of the travel bag, whose total dimensions of the three sides described above are 116 (cm), are larger than the threshold α.

The threshold α may include multiple threshold αi. In this disclosure, the threshold α shall include a first threshold α1 and a second threshold α2 that is a larger value than the first threshold α1, but the number of thresholds is not limited to two. Specifically, the first threshold α1 may be specified as 50 (cm) and the second threshold α2 as 100 (cm). In such a case, the dimensions of the travel bag are determined to be larger than the second threshold α2 because the total dimension of the three sides of the travel bag described above is 116 (cm).

S108: The controller 25 presents the user 3 with a predetermined luggage storage space s.

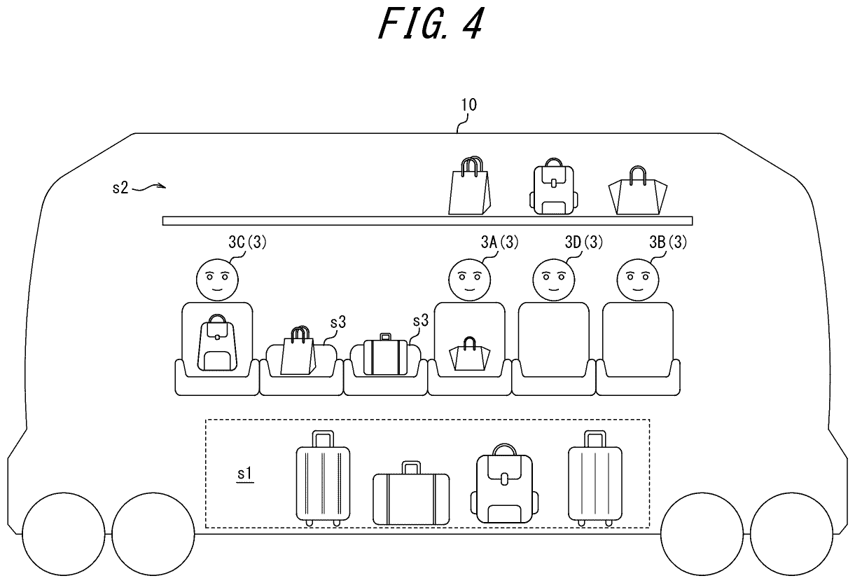

FIG. 4 is a schematic diagram illustrating an example of a luggage storage space in a vehicle. In the example illustrated in FIG. 4, the predetermined luggage storage spaces s are a trunk room s1 under the cabin and a luggage rack s2 installed in the upper part of the cabin. For the user 3, the controller 25 (i) if it determines that the luggage b is the consigned hand luggage b2, presents the luggage b to be stored in the trunk room s1 under the cabin, (ii) if the measured dimension of the luggage b is larger than the second threshold α2, presents the luggage b to be stored in the trunk room s1, (iii) if the measured dimension of the luggage b is larger than the first threshold α1 and equal to or smaller than the second threshold α2, presents the luggage b to be stored in the luggage rack s2, and (iv) if the measured dimension of the luggage b is equal to or smaller than the first threshold α1, not present the predetermined luggage storage space s. In case (iv), the user 3 may carry the luggage b into the cabin as the portable hand luggage b1, be seated on a seat and hold the luggage b, store the luggage b in the luggage rack s2, or, if there are many empty seats in the cabin, temporarily place the luggage b on an empty seat s3 until another user is seated. However, the predetermined luggage storage space s is not limited to the trunk room s1 and the luggage rack s2, but any location in the vehicle 10 may be presented. Luggage b that is larger than the third threshold α3, where the total dimension of the three sides is a larger value than the second threshold α2, may be included in the hand luggage b3 that cannot be brought into the vehicle 10.

The assistance apparatus 20 has an output interface 23 with the

speaker 23A and the display 23B. The controller 25 may present the predetermined luggage storage space s to the user 3 by audio output from the speaker 23A, text and video displayed on the display 23B, or both audio and text and video. If the hand luggage b3 that cannot be brought into the vehicle 10 is detected, the controller 25 may use the speaker 23A and the display 23B to indicate to the user 3 that the hand luggage b3 cannot be brought into the vehicle 10.

S109: The controller 25 determines whether the vehicle 10 has passed all stops in the operation route. If all stops have been passed, the information processing is terminated; if not all stops have been passed, the system returns to S103 to continue the information processing.

As described above, the assistance apparatus 20 according to the present embodiment determines the type of luggage that the user 3 brings into the vehicle 10 based on an acquired camera image and measures the dimension of the luggage, and presents a predetermined luggage storage space to the user 3 if the determined type of the luggage is predetermined luggage or if the measured dimension of the luggage is equal to or larger than a threshold.

According to such a configuration, if the type of the luggage b is predetermined luggage bp, or if the measured dimensions of the luggage b are larger than the threshold α, a predetermined luggage storage space is presented to the user 3 of the vehicle 10. This improves the technology related to storing luggage that users bring into vehicles in that the user 3 can place their bulky luggage in the predetermined luggage storage space, so that the luggage does not get in the way of other users and improves the comfort of the user 3.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which the configuration and operations of the assistance apparatus 20 in the above embodiment are distributed to multiple computers capable of communicating with each other can be implemented. For example, an embodiment in which some or all of the components of the assistance apparatus 20 are provided in the vehicle 10 can also be implemented. For example, an in-vehicle apparatus mounted in the vehicle 10 may be equipped with some or all of the components of the assistance apparatus 20.

For example, an embodiment in which a general purpose computer functions as the assistance apparatus 20 according to the above embodiment can also be implemented. Specifically, a program in which processes for realizing the functions of the assistance apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

In an example, the assistance apparatus 20 may be used to provide Mobility as a Service (MaaS), a service that leverages mobility.

1. An assistance apparatus comprising:
an input interface including a camera; and
a controller configured to:
acquire a camera image captured by the camera;
determine a type of luggage that a user brings into a vehicle based on the acquired camera image and measure a dimension of the luggage; and
present a predetermined luggage storage space to the user in a case in which the determined type of the luggage is predetermined luggage or in a case in which the measured dimension of the luggage is larger than a threshold.

2. The assistance apparatus according to claim 1, wherein
the predetermined luggage storage space is a trunk room under a cabin and a luggage rack installed in an upper part of the cabin,
the threshold includes a first threshold and a second threshold having a larger value than the first threshold, and
the controller is configured to present to the user, as the predetermined luggage storage space, the luggage rack in a case in which the measured dimension of the luggage is larger than the first threshold and equal to or smaller than the second threshold, and the trunk room in a case in which the measured dimension of the luggage is larger than the second threshold.

3. The assistance apparatus according to claim 1, further comprising an output interface including a speaker and a display,
wherein the controller is configured to present the predetermined luggage storage space to the user by audio output from the speaker, text and video displayed on the display, or both of the audio and the text and video.

4. The assistance apparatus according to claim 1, wherein the controller is configured to measure the dimension of the luggage, which is included in the acquired camera image, using a measurement application.

5. An assistance method performed by an assistance apparatus, the assistance method comprising:
determining a type of luggage that a user brings into a vehicle based on an acquired camera image;
measuring a dimension of the luggage; and
presenting a predetermined luggage storage space to the user in a case in which the determined type of the luggage is predetermined luggage or in a case in which the measured dimension of the luggage is larger than a threshold.

6. A method, by a processor, for improving travel mobility as a service (MaaS), comprising processing steps executed by the assistance apparatus according to claim 1.
